(19) United States
(12) Patent Application Publication
(10) Pub. No.: US 2010/0035086 A1
(43) Pub. Date: Feb. 11, 2010

(54) IRON NITRIDE MAGNETIC POWDER AND MAGNETIC RECORDING MEDIUM COMPRISING THE SAME

(75) Inventors: Tetsutaro INOUE, Osaka (JP); Yuji SASAKI, Osaka (JP)

Correspondence Address: BIRCH STEWART KOLASCH & BIRCH, PO BOX 747, FALLS CHURCH, VA, 22040-0747, US

(73) Assignee: HITACHI MAXELL. LTD., Ibaraki-shi (JP)

(21) Appl. No.: 12/534,998

(22) Filed: Aug. 4, 2009

(30) Foreign Application Priority Data
Aug. 5, 2008 (JP) 2008-202238

(51) Int. Cl. G11B 5/39; G11B 5/33; H01F 1/04

(52) U.S. Cl. 428/811.2; 428/812; 252/62.55

(57) ABSTRACT

A spherical or ellipsoidal iron nitride magnetic powder having a core comprising iron nitride including a Fe₁₆N₂ phase as a primary phase and an outer layer containing yttrium (Y) and aluminum (Al), in which an average particle size r of the iron nitride magnetic powder is 20 nm or less, an average diameter d of the core is 4 to 10 nm, and a ratio of r to d (r/d) is 2 to 3, and average content of yttrium and aluminum in the outer layer are from 0.9 to 5 atomic % and from 30 to 50 atomic %, respectively, each based on the total number of iron atoms in the iron nitride magnetic powder, and standard deviations of the contents of yttrium and aluminum are 0.6 atomic % or less and 17 atomic % or less, respectively.

The present application is filed claiming the priority based on Japanese Patent Application No. 2008-202238 filed on Aug. 5, 2008 under the Paris Convention, the entire content of which is herein incorporated on by reference.

### FIELD OF THE INVENTION

The present invention relates to an iron nitride magnetic powder for use in a coating type magnetic recording medium and a magnetic recording medium comprising such an iron nitride magnetic powder. In particular, the present invention relates to a high density magnetic recording medium which generates low noise and has an excellent SNR (sound to noise ratio) when used with a recording/reproducing system comprising a high-sensitivity head such as a GMR head.

### DESCRIPTION OF THE BACKGROUND ART

It is required for a coating type magnetic recording medium comprising a magnetic layer containing a magnetic powder and a binder, formed on a non-magnetic substrate, to have a further improved recording density in accordance with the transition of recording-reproduction systems from analog ones to digital ones. This requirement has been growing year after year, especially in the field of high density digital video tapes, computer backup tapes, and the like.

In order to cope with the trend of recording with shorter wavelengths which is essential for improving the recording density, it is necessary to improve a reproduction output in a short wavelength range. Therefore, an improvement in a magnetic flux density through an improvement in the filling property of a magnetic powder by decreasing the particle size of the magnetic powder or reduction in demagnetization in recording in a short wavelength region by increasing the coercive force of the magnetic powder has been investigated. For example, in an acicular magnetic powder used for a high density magnetic recording tape, metal iron magnetic powder having a major axis length of about 45 nm and a high coercive force of about 238.9 kA/m has been realized (JP-A-03-49026, JP-A-10-83906 and JP-A-10-340805). However, with the magnetic recording medium using the acicular magnetic powder described above, extensive decrease of the particle size from the above-mentioned major axis length is becoming difficult. This is because that the acicular metal iron magnetic powder exhibits a high coercive force depending on magnetic shape anisotropy resulting from the acicular shape, and hence the decrease of the particle size leads to the reduction of the coercive force due to the inevitable decrease of an acicular ratio (a ratio of a major axis length to a minor axis length).

Accordingly, JP-A-2000-277311 discloses a magnetic recording medium using an iron nitride magnetic powder comprising a Fe₁₆N₂ phase as a primary phase as magnetic powder completely different from the above-mentioned acicular magnetic powder. Although the iron nitride magnetic powder has a high coercive force, it may have a drawback that particle-derived noise is large since it has a BET specific surface area of about 10 m²/g and its particle size is large, or a drawback that a magnetic flux density of the medium is excessively large and recording demagnetization is increased since the magnetic powder has a high saturation magnetization of about 190 to 200 Am²/kg. Accordingly, it is necessary to optimize a particle size and magnetic characteristics for employing such an iron nitride magnetic powder in a high density magnetic recording medium.

In view of the above circumstances, JP-A-2004-273094 proposes a magnetic recording medium using an iron nitride magnetic powder which consists of a core comprising a Fe₁₆N₂ phase and an outer layer containing at least one element selected from the group consisting of rare earth elements, aluminum (Al) and silicon (Si), and which has an average particle size of 5 to 50 nm. Since the proposed iron nitride magnetic powder has crystal magnetic anisotropy, it has a high coercive force and a moderate saturation magnetization even though the powder consists of fine particles, and it is characterized in that a magnetic layer is easily highly filled with the magnetic powder when forming a magnetic layer since the particles of the magnetic powder have spherical or ellipsoidal shapes in contrast to the conventional acicular magnetic powder. Therefore, the proposed iron nitride magnetic powder can advantageously achieve a high magnetic flux density and attain a high output.

### SUMMARY OF THE INVENTION

In a data recording system for a computer, magnetoresistance effect magnetic head (MR heads) has been employed in place of a conventional induction head as a reproduction head used for reproducing recorded information. Recently, investigated are the applications of a high-sensitivity heads (hereinafter, collectively referred to as “GMR head”) such as a giant magnetoresistance effect magnetic head (GMR head) and a tunnel magnetoresistance effect magnetic head (TMR head), which have a higher sensitivity. Such a high-sensitivity head such as the GMR head has a magnetoresistance ratio of 8% or more and this magnetoresistance ratio is higher than that of a MR head. Therefore, in a system using such a high-sensitivity head, medium noise resulting from a magnetic recording medium dominates a SNR (signal noise ratio) of the system, since noise resulting from the system can be considerably reduced. Accordingly, in the case of the iron nitride magnetic powder described above, it is necessary to increase an output by improving magnetic characteristics and simultaneously realize low noise.

In a coating type magnetic recording medium, when the medium noise is evaluated in terms of the amount of the magnetic powder filled in a magnetic layer, the medium noise is reduced as the number of the magnetic powder particles present in a recording bit is increased. Accordingly, in order to reduce the medium noise, it is effective to use fine magnetic powder and to improve the filling property of the magnetic powder in the magnetic layer. Therefore, it is envisaged that, if fine iron nitride magnetic powder having a small average particle size is used among the iron nitride magnetic powder disclosed in JP-A-2004-273094, the reproduction output may be improved and noise may also be reduced.

Then, the present inventors have made investigations using fine iron nitride magnetic powder with a particle size of 20 nm or less among the above-mentioned iron nitride magnetic powders in order to develop a magnetic recording medium which has low noise and can attain a high SNR. However, it was revealed that if the magnetic recording medium using the fine iron nitride magnetic powder like this is applied to a magnetic recording and reproduction system comprising a high-sensitivity head such as a GMR head, the output in a short wavelength region is improved to some extent, but noise is inversely increased and the SNR is rather decreased.

Accordingly, an object of the present invention is to provide a magnetic recording medium using a fine iron nitride magnetic powder, which can realize low noise and has an excellent SNR even when the magnetic recording medium is applied to a magnetic recording and reproduction system comprising a high-sensitivity head such as a GMR head.

The present invention provides a spherical or ellipsoidal iron nitride magnetic powder having a core comprising iron nitride including a Fe₁₆N₂ phase as a primary phase and an outer layer containing yttrium (Y) and aluminum (Al), wherein an average particle size r of the iron nitride magnetic powder is 20 nm or less, preferably 18 nm or less, an average diameter d of the core is 4 to 10 nm, preferably 5 to 9 nm, and a ratio of r to d (r/d) is 2 to 3, and

wherein an average content of yttrium in the outer layer is from 0.9 to 5 atomic %, preferably from 1.5 to 4.0 atomic %, based on the total number of iron atoms in the iron nitride magnetic powder and a standard deviation of the content of yttrium is 0.6 atomic % or less, preferably 0.5 atomic % or less, and an average content of aluminum is from 30 to 50 atomic %, preferably from 32 to 40 atomic %, based on the total number of iron atoms in the iron nitride magnetic powder and a standard deviation of the content of aluminum is 17 atomic % or less, preferably 14 atomic % or less, when elemental analyses are carried out at 10 points of the outer layer of each of 50 particles of the iron nitride magnetic powder by an X-ray analysis-transmission electron microscope (TEM-EDX).

Since the iron nitride magnetic powder is the fine iron nitride magnetic powder having an average particle size of 20 nm or less, the magnetic layer densely filled with the iron nitride magnetic powder can be formed. Further, since the core contains iron nitride including a Fe₁₆N₂ phase as a primary phase and the average diameter of the core is 4 to 10 nm, certain magnetic characteristics can be attained. Furthermore, when the magnetic layer is densely filled with the fine iron nitride magnetic powder, the magnetic interaction between the particles of the iron nitride magnetic powder increases. However, since each particle of the iron nitride magnetic powder has a thick outer layer with a r/d ratio of 2 to 3 despite it is fine powder, a sufficient distance between the cores of the iron nitride magnetic powder particles adjacent to each other can be kept. Therefore, the outer layer of the iron nitride magnetic powder contains a large amount of yttrium and aluminum, that is, yttrium in an amount of from 0.9 to 5 atomic % and aluminum in an amount of from 30 to 50 atomic %, each based on the total number of iron atoms. These elements are uniformly distributed in the outer layer since the standard deviation of the contents of yttrium and aluminum in the outer layer are 0.6 atomic % or less and 17 atomic % or less, respectively. Accordingly, the thickness of the outer layer is uniform and the magnetic interaction between the particles of the iron nitride magnetic powder can be sufficiently reduced.

Further, the magnetic recording medium of the present invention comprises a non-magnetic substrate and a magnetic layer containing the iron nitride magnetic powder and a binder on the non-magnetic substrate. Since a magnetic interaction between the particles of the iron nitride magnetic powder is small even if the magnetic recording medium is densely filled with the iron nitride magnetic powder, a magnetic recording medium causing low noise and having an excellent SNR can be obtained when a magnetic layer is formed using the iron nitride magnetic powder of the present invention.

The magnetic recording medium can be preferably used for a magnetic recording and reproduction system comprising a magnetoresistance effect element with a magnetoresistance ratio of at least 8% as a reproduction head. The magnetic recording medium comprising the iron nitride magnetic powder of the present invention can be suitably used for a system comprising a high-sensitivity head with a high magnetoresistance ratio since it can reduce noise. Further, in the iron nitride magnetic powder, magnetic characteristics such as a coercive force may be slightly deteriorated by increasing the thickness of the outer layer, but such a deterioration in the magnetic characteristics can be compensated by the use of the high-sensitivity head. Therefore, a magnetic recording medium achieving a high SNR can be obtained.

As described above, the present invention provides a magnetic recording medium comprising the fine iron nitride magnetic powder, which can realize low noise and has an excellent SNR when the magnetic recording medium is applied to a magnetic recording and reproduction system comprising a high-sensitivity head such as a GMR head.

### DETAILED DESCRIPTION OF THE INVENTION

One of the reasons why a magnetic recording medium causes high noise in the case of using a fine iron nitride magnetic powder may be that the magnetic interaction between the particles of iron nitride magnetic powder adjacent to each other increases as the a magnetic recording medium is more densely filled with the magnetic powder.

In order to reduce the magnetic interaction between the magnetic powder particles, it is necessary to magnetically isolate the magnetic powder particles from one another, that is, to separate the magnetic powder particles from one another with a non-magnetic component. In the iron nitride magnetic powder having a Fe₁₆N₂ phase exhibiting high crystal magnetic anisotropy in cores, it may be effective to keep a distance between cores containing the iron nitride phase, that is, to increase the thickness of the outer layers of the magnetic powder particles. However, the increase of the thickness of the outer layer may reduce the magnetic interaction between the particles of the iron nitride magnetic powder adjacent to each other, while the size of the cores of the particles of the iron nitride magnetic powder decrease. Particularly, when the size of the cores becomes too small, a superparamagnetic property appears, resulting in the decrease of a coercive force. When the thickness of the outer layer becomes too large, the saturation magnetization decreases since the ratio of the core volume to the magnetic powder volume decreases. Thus, it is necessary to select the thickness of the outer layer, in which the magnetic interaction between the particles of the iron nitride magnetic powder adjacent to each other is suppressed and a magnetic property within a range suitable for high density recording characteristics is achieved.

In view of the above circumstances, the present inventors have found that, in the case of an iron nitride magnetic powder having an outer layer containing yttrium and aluminum around a core comprising iron nitride containing a Fe₁₆N₂ phase as a primary phase, the magnetic recording medium, which considerably reduces noise and has an excellent SNR even if the magnetic recording medium is applied to a magnetic recording and reproduction system comprising a high-sensitivity head such as a GMR head, can be obtained, when the average particle size r of the iron nitride magnetic powder is 20 nm or less, the average diameter d of the core of the iron nitride magnetic powder is 4 to 10 nm, the ratio r/d is 2 to 3, and the average value of the contents of yttrium and aluminum are 0.9 to 5 atomic % and 30 to 50 atomic %, respectively, based on the total number of iron atoms in the iron nitride magnetic powder, and the standard deviation of the contents of yttrium and aluminum are 0.6 atomic % or less and 17 atomic % or less, respectively, when elemental analyses are carried out at 10 points of the outer layer of each of 50 particles of the iron nitride magnetic powder by an X-ray analysis-transmission electron microscope (TEM-EDX).

When the average particle size r of the iron nitride magnetic powder is 20 nm or less, the average diameter of the core is 4 to 10 nm and the ratio r/d is 2 to 3, it is possible to keep a distance between the cores of the particles of the iron nitride magnetic powder for reducing the magnetic interaction between the particles of the iron nitride magnetic powder adjacent to each other without largely deteriorating a coercive force and a saturation magnetization. If the average diameter of the core is smaller than 4 nm, a superparamagnetic property appears, a coercive force significantly decreases and an output greatly reduces even if the core contains iron nitride containing the Fe₁₆N₂ phase as a primary phase. If the average size of the core is larger than 10 nm, a thick outer layer cannot be formed in the fine iron nitride magnetic powder of the present invention having an average particle size of 20 nm or less, and consequently the magnetic interaction between the cores increases and thus the noise increases. The average particle size can be increased to exceed 20 nm, but the significance of the use of the fine iron nitride magnetic powder for the purpose of increasing an output and reducing noise is lost. In addition, if the average particle size becomes too small, the dispersion of the iron nitride magnetic powder becomes difficult. Therefore, the average particle size is preferably 10 nm or more. If the ratio r/d is smaller than 2, the thickness of the outer layer is small and therefore no adequate effect of reducing noise is achieved. On the other hand, when the r/d is larger than 3, since the thickness of the outer layer is too large and the ratio of the core volume to the magnetic powder volume decreases, the saturation magnetization is greatly reduced and the output is significantly reduced.

In order to form a thick outer layer like the above outer layer, the contents of the coating elements at the periphery of the core need to be increased more than those of the conventional ones. In the conventional iron nitride magnetic powder described in JP-A-2004-273094 and so on, as the coating elements, rare earth elements such as yttrium, ytterbium (Yb) and neodymium (Nd); aluminum; nonmetallic elements such as silicon (Si); alkaline earth metal elements such as barium (Ba), strontium (Sr) and manganese (Mn); boron (B) or phosphorus (P) are used. Among these elements, yttrium and aluminum are elements with which a starting material is relatively easily coated by a coating treatment, and therefore these elements can be coated on the starting material in a large amount and they can impart dispersibility in the binder or a shape-maintaining property to the resulting particles of the iron nitride magnetic powder. Thus, the amounts of these coating elements which enable the formation of the thick outer layer have been investigated. Consequently, it has been found that the thick outer layer can be formed when the average contents of yttrium and aluminum are 0.9 to 5 atomic % and 30 to 50 atomic %, respectively, based on the total number of iron atoms in the iron nitride magnetic powder. When the average contents of yttrium and aluminum exceed the respective upper limit of the above ranges, the thickness of the outer layer becomes too large and an outer layer having a uniform thickness is hardly formed, and consequently the noise is easily increased. When the average contents of yttrium and aluminum are smaller than the respective lower limit of the above ranges, the outer layer becomes thin, and consequently the magnetic interaction between the particles of the iron nitride magnetic powder becomes large to increase noise.

Furthermore, with the iron nitride magnetic powder coated with large amounts of yttrium and aluminum, it is necessary to adjust the standard deviations of the contents of yttrium and aluminum in the outer layer to 0.6 atomic % or less and 17 atomic % or less, respectively as described above. In order to form a thick outer layer, it is necessary to increase the contents of yttrium and aluminum. However, it has been found that an effect of reducing noise cannot be achieved as much as expected by simply increasing the contents of these elements. Although a reason for this has not been clarified, it may be assumed to be due to the fact that in a coating treatment in which the outer layer containing large amounts of these elements is formed, coating with these elements becomes less uniform. That is, in order to coat the surface of the core with these elements, it is necessary for a solution containing compounds comprising these elements to be added to a dispersion in which the starting material is dispersed during the coating treatment to precipitate and deposit these elements in the form of a hydroxide or a hydrate on the surface of the starting material. It may be assumed that, if the contents of the coating elements are increased at this time, the hydroxide or the hydrate described above tend to be unevenly distributed on the surface of the starting material and thereby thin portions are easily formed in the outer layer. According to the investigations of the present inventors, it has been found that these elements are distributed in the outer layer in such a way that the standard deviations of the contents of yttrium and aluminum in the outer layer are 0.6 atomic % or less and 17 atomic % or less, respectively, as described above, to effectively reduce noise. The lower limit of the standard deviation of the content of each element is not particularly limited because when the standard deviation of the contents of the coating element is smaller, an outer layer in which the coating element is more uniformly distributed can be formed. From the viewpoint of productivity, preferably, the standard deviation of the contents of yttrium is at least 0.1 atomic % and that of the content of aluminum is at least 2 atomic %.

In one embodiment of the present invention, besides the Fe₁₆N₂ phase, the core may contain other crystalline phase such as a Fe₈N₂ phase, a Fe₄N phase, a Fe₃N phase and an α-Fe phase. The presence of the other crystalline phase in the core makes it possible to adjust the coercive force. The iron atoms in the iron nitride may be replaced with other transition metal element such as cobalt (Co) in order to improve corrosion resistance. Furthermore, as long as the outer layer contains yttrium and aluminum in the amounts described above, other coating elements may be used together with these elements. Examples of the other coating element include rare earth elements similar to those described in JP-A-2004-273094, alkaline earth metal elements, silicon, boron and phosphorus. However, the total content of the other coating element(s) is preferably 0.2 to 2 atomic % with respect to Fe since the thickness of the outer layer becomes less uniform when the total content of the other coating element(s) is too large.

Hereinafter, a suitable method for producing the iron nitride magnetic powder of the present invention will be described.

Preferably, an iron oxide or hydroxide is used as a starting material. Specific examples of the iron oxide or hydroxides include hematite, magnetite, geothite and the like. The average particle size of the starting material is not particularly limited, but it is preferably about 5 to 25 nm. When the average particle size of the starting material is too small, particles tend to be sintered during a reduction treatment. When the average particle size is too large, the iron oxide or hydroxide is less uniformly reduced in the reduction treatment, and the control of the average particle size and magnetic characteristics of the resultant iron nitride magnetic powder tends to become difficult.

Yttrium and/or aluminum may be added to the starting material in advance. Since yttrium and aluminum hardly form an alloy with Fe, these elements are hardly introduced into iron nitride in a reduction process. Therefore, by the use of a starting material already containing these elements, compounds such as oxides comprising these elements are easily formed on the surfaces of the cores. Particularly, when a thick outer layer is formed, it is necessary to coat the surface of the starting material with a large amount of aluminum. However, if the surface of the starting material is coated with a large amount of a compound comprising aluminum by a coating treatment, the surface of the starting material is unevenly coated with the compound comprising aluminum to provide varying thicknesses. In contrast, if the starting material contains a certain amount of Al in advance, an outer layer is easily formed, in which outer layer an oxide of aluminum or the like is more uniformly distributed on the surface of the core than the case of only the coating treatment. However, when the amounts of yttrium and aluminum in the starting material are too large, the formation of iron nitride in the core tends to be impaired. Thus, preferably, the average contents of these elements is 0.05 to 1.0 atomic % for Y and 2 to 30 atomic % for Al based on the total number of iron atoms in the starting material.

In the present embodiment, a coating treatment to coat the above starting material with the compounds comprising these coating elements is performed so that the outer layer contains yttrium and aluminum. By such a coating treatment, the core can be coated with an outer layer containing compounds such as oxides comprising these elements. Examples of the compounds comprising these coating elements include hydroxides, nitrates and sulfates of these elements. The amounts of these compounds to be added to the starting material may be within the ranges of the average contents of the above coating elements based on the total number of iron atoms in the starting material, and may be within the ranges of the amounts calculated by subtracting the contents of yttrium and aluminum contained in the starting material from the average contents of the above coating elements when the starting material contains yttrium and aluminum. In one example of the coating treatment, the starting material is dispersed in an aqueous solution of an alkali or an acid and a solution containing compounds having the above elements is added to the resulting dispersion to precipitate and deposit hydroxides or hydrates of these elements on the powder of the starting material by a neutralization reaction. In this case, it is preferable to adjust the addition rate of the compounds comprising these coating elements to the starting material in order to form an outer layer uniformly coated with the large amounts of the coating elements. Specifically, a solution containing a compound of yttrium and a compound of aluminum is prepared and mixed with the starting material in such a way that the total addition rate of both compounds per gram of the starting material is 0.1 g/hr or lower. When the addition rate is higher than 0.1 g/hr, the thickness of the outer layer tends to become uneven and iron nitride magnetic powder, in which standard deviations of the contents of the elements are within the above-mentioned range, are hardly obtained. In addition, a smaller addition rate is preferable since coating can be uniformly performed. The addition rate is preferably 0.04 g/hr or higher per gram of the starting material in consideration of the productivity.

Next, the starting material coated as described above is reduced in a hydrogen stream. A reducing gas in a reduction treatment is not particularly limited and may be a reducing gas such as a carbon monoxide gas other than the hydrogen gas may be used. Preferably, a reduction temperature is 300 to 600° C. When the reduction temperature is lower than 300° C., the reduction does not adequately proceed. When the reduction temperature is higher than 600° C., the powder is easily to be sintered.

After the reduction, the resulting iron magnetic powder is subjected to a nitriding treatment to obtain iron nitride magnetic powder comprising a core containing a Fe₁₆N₂ phase and an outer layer containing compounds such as the oxides of yttrium and aluminum. Desirably, an ammonia-containing gas is used in the nitriding treatment. In the nitriding treatment, an ammonia gas may be used singly, or a gas mixture of an ammonia gas and a carrier gas such as a hydrogen gas, a helium gas, a nitrogen gas or an argon gas may be used. The nitrogen gas is particularly preferable because it is inexpensive.

The nitriding temperature is preferably from 100 to 300° C. When the nitriding temperature is too low, the nitriding does not sufficiently proceed, resulting in a poor effect on increasing the coercive force. When the nitriding temperature is too high, the nitriding is excessively accelerated to increase the proportion of a Fe₄N phase or a Fe₃N phase, and the coercive force is rather reduced and the excessive decrease of the saturation magnetization is apt to occur. Preferably, conditions for the nitriding treatment are selected so that the content of nitrogen is 1 to 20 atomic % relative to iron. When the content of nitrogen is too small, the amount of a Fe₁₆N₂ phase produced decreases and an effect of improving the coercive force becomes small. When the content of nitrogen is too high, a Fe₄N phase or a Fe₃N phase is easily formed, and the coercive force is rather reduced and the excessive decrease of the saturation magnetization is apt to occur.

The iron nitride magnetic powder produced as described above preferably has a coercive force of 119.4 to 318.5 kA/m and a saturation magnetization of 39 to 160 Am²/kg. By employing the iron nitride magnetic powder having a high coercive force and a high saturation magnetization as described above, a high reproduction output can be achieved in recording in a short wavelength region.

The magnetic recording medium of the present invention can be prepared by applying a magnetic coating composition, which is prepared by dispersing and mixing the above-mentioned iron nitride magnetic powder and a binder in a solvent, onto a non-magnetic substrate and drying the coating composition to form a magnetic layer.

As the non-magnetic substrate, any of conventional non-magnetic substrates for magnetic recording media may be used. Examples thereof include plastic films with a thickness of usually from 2 to 15 μm, particularly from 2 to 7 μm, made from polyesters such as polyethylene terephthalate and polyethylene naphthalate, polyolefins, cellulose triacetate, polycarbonate, polyamide, polyimide, polyamideimide, polysulfone, aramid, aromatic polyamide, or the like.

Examples of a binder for use in the magnetic layer include vinyl chloride resins, nitrocellulose resins, epoxy resins and polyurethane resins. Specific examples of the vinyl chloride resins include vinyl chloride resins, vinyl chloride-vinyl acetate copolymer resins, vinyl chloride-vinyl alcohol copolymer resins, vinyl chloride-vinyl acetate-vinyl alcohol copolymer resins, vinyl chloride-vinyl acetate-maleic anhydride copolymer resins, vinyl chloride-hydroxyl group-containing alkyl acrylate copolymer resins, and the like. Among them, the combination of a vinyl chloride resin and a polyurethane resin is preferable, and the combination of a vinyl chloride-hydroxyl group-containing alkyl acrylate copolymer resin and a polyurethane resin is more preferable. These binders preferably have a functional group in order to improve the dispersibility of the iron nitride magnetic powder and also the filling property. Specific examples of such a functional group include a group of the formula: COOM, SO₃M, OSO₃M, P═O(OM)₃ or O—P═O(OM)₂ (in which M is a hydrogen atom, an alkali metal salt or an amine salt), a group of the formula: OH, NR¹R² or NR³R⁴R⁵ (in which R¹, R², R³, R⁴ and R⁵ are independently of each other a hydrogen atom or a hydrocarbon group usually having 1 to 10 carbon atoms), an epoxy group, and the like. When two or more resins are used in combination, the functional groups of the resins preferably have the same polarity. Among others, the combination of the resins both having —SO₃M groups is preferable. The binder is used in an amount of from 7 to 50 parts by weight, preferably from 10 to 35 parts by weight, per 100 parts by weight of the iron nitride magnetic powder. Preferably, 5 to 30 parts by weight of a vinyl chloride resin and 2 to 20 parts by weight of a polyurethane resin are used in combination.

Preferably, the binder is used in combination with a thermosetting crosslinking agent which is bound to the functional groups contained in the binder to form a crosslinked structure. Specific examples of the crosslinking agent include various isocyanate compounds such as tolylene diisocyanate, hexamethylene diisocyanate, and isophorone diisocyanate; reaction products of isocyanate compounds with compounds having a plurality of hydroxyl groups, such as trimethylolpropane; and condensation products of isocyanate compounds. The crosslinking agent is used in an amount of usually from 10 to 50 parts by weight per 100 parts by weight of the binder.

The magnetic layer may contain additives such as carbon black, a lubricant, and non-magnetic powder in order to improve the characteristics of the magnetic layer such as electric conductivity, surface lubricity and durability. Specific examples of carbon black include acetylene black, furnace black and thermal black. Preferably, the content of carbon black is from 0.2 to 5 parts by weight per 100 parts by weight of the iron nitride magnetic powder. Specific examples of the lubricant include fatty acids, fatty acid esters, fatty acid amides, and the like each having 10 to 30 carbon atoms. Preferably, the content of the lubricant is from 0.2 to 3 parts by weight per 100 parts by weight of the iron nitride magnetic powder. As the non-magnetic powder, for example, alumina, silica or the like may be used. Preferably, the content of the non-magnetic powder is 1 to 20 parts by weight per 100 parts by weight of the iron nitride magnetic powder.

A magnetic coating composition is prepared by mixing the iron nitride magnetic powder and the binder, and optionally an additive or additives in a solvent. As the solvent, organic solvents hitherto used for the preparation of the magnetic coating composition can be used. Specific examples of the organic solvents include cyclohexanone, toluene, methyl ethyl ketone, tetrahydrofurane and the like. Any process for producing coating composition that is known in this art field may be employed for the preparation of the magnetic coating composition. Particularly, the combination of a kneading step with a kneader with a primary dispersion step is preferable. In the primary dispersion step, use of a sand mill is desirable since it improves the dispersibility of the powder particles and enables to control the surface nature of the powder particles.

The thickness of the magnetic layer is preferably 300 nm or less, more preferably 10 to 300 nm, furthermore preferably 10 to 250 nm, most preferably 10 to 200 nm, in order to avoid the reduction of output due to demagnetization, which is an essential problem in longitudinal recording. When the thickness of the magnetic layer is larger than 300 nm, the reproduction output decreases due to thickness loss, or the distortion of reproduction output due to the saturation of a magnetic flux tends to occur when the high-sensitivity reproduction head such as a GMR head is used because the product of a residual magnetic flux density and the thickness is too large. When the thickness of the magnetic layer is less than 10 nm, a uniform magnetic layer is hardly formed. Since the magnetic powder of the present invention is extremely fine powder having an average particle size of 20 nm or less and has a spherical or ellipsoidal shape, it can form even an extremely thin magnetic layer which almost cannot be formed from conventional acicular magnetic powder.

In the case of a magnetic tape, the coercive force of the magnetic layer in the longitudinal direction is preferably 159.2 to 398.0 kA/m, more preferably 159.2 to 318.4 kA/m. If the coercive force in the longitudinal direction is less than 159.2 kA/m, the output tends to decrease in recording in a short wavelength region due to demagnetization in a demagnetizing field. If the coercive force in the longitudinal direction exceeds 398.0 kA/m, recording with a magnetic head tends to be difficult. Further, a squareness in the longitudinal direction (Br_{in-plane longitudinal}/Bm_{in-plane longitudinal}) is preferably 0.6 to 0.9, more preferably 0.8 to 0.9. However, when an output in a short wavelength region is given a high priority, an orientation-free tape having a squareness of about 0.5 may be made. Further, in an application where the output in a short wavelength region is particularly required, the iron nitride magnetic powder may be vertically oriented. In this case, the coercive force in the vertical direction is preferably 159.2 to 398.0 kA/m, more preferably 159.2 to 318.4 kA/m. As with the longitudinal direction, if the coercive force in the vertical direction is less than 159.2 kA/m, the output tends to decrease in recording in a short wavelength region due to demagnetization in a demagnetizing field. If the coercive force in the vertical direction exceeds 398.0 kA/m, recording with a magnetic head tends to be difficult. Further, the squareness in the vertical direction (Br_{vertical}/Bm_{vertical}) is preferably 0.5 to 0.8, more preferably 0.55 to 0.75.

Furthermore, the product of a saturated magnetic flux density and a thickness of a magnetic layer is preferably 0.001 to 0.1 μTm, more preferably 0.0015 to 0.05 μTm, regardless of the orientation direction. When the product is less than 0.001 μTm, the reproduction output tends to decrease in the case of using a MR head. When the product exceeds 0.1 μTm, the output tends to decrease in a short wavelength region. Further, the average surface roughness (Ra) of the magnetic layer is preferably 1.0 to 3.2 nm. If the average surface roughness is within the above range, good contact between the magnetic layer and the reproduction head can be secured and the reproduction output can be improved, when a high-sensitivity head such as a GMR head is used for the reproduction head.

The magnetic recording medium of the present invention may have a primer layer between the non-magnetic substrate and the magnetic layer. The thickness of the primer layer is preferably 0.1 to 3.0 μm, more preferably 0.15 to 2.5 μm. When the thickness of the primer layer is less than 0.1 μm, durability tends to deteriorate. When the thickness of the primer layer exceeds 3.0 μm, the entire thickness of the magnetic recording medium increases, and therefore a tape length per reel of tape tends to shorten and the recording capacity per reel tends to decrease. The primer layer may contain non-magnetic powder such as titanium oxide, iron oxide, aluminum oxide or the like; or magnetic powder such as γ-iron oxide, Co-γ-iron oxide, magnetite, chromium oxide, a Fe—Ni alloy, a Fe—Co alloy, a Fe—Ni—Co alloy, barium ferrite, strontium ferrite, Mn—Zn ferrite, Ni—Zn ferrite, Ni—Cu ferrite, Cu—Zn ferrite, Mg—Zn ferrite or the like for the purpose of controlling the viscosity of the coating composition and the rigidity of the tape. These powder may be used alone or may be used as a mixture of two or more kinds. The primer layer may preferably contain carbon black and a lubricant so as to impart electric conductivity and surface lubricity to the magnetic layer. As the carbon black and the lubricant, the same materials as those used in the formation of the magnetic layer may be used. As a binder for use in the primer layer, the same resin as one used in the above magnetic layer may be used.

The magnetic recording medium of the present invention may have a backcoat layer on the other surface of the non-magnetic substrate opposite to the surface on which the magnetic layer is formed. The thickness of the backcoat layer is preferably 0.2 to 0.8 μm, more preferably 0.3 to 0.8 μm. Preferably, the backcoat layer contains carbon black such as acetylene black, furnace black or thermal black. As a binder for use in the backcoat layer, the same resin as that used in the magnetic layer may be used. Among these resins, a combination of a cellulose resin and a polyurethane resin is preferably used in order to reduce a friction coefficient and to improve running performance of the magnetic medium.

The magnetic recording medium of the present invention can be suitably used for a magnetic recording and reproduction system comprising a high-sensitivity head having a high magnetoresistance ratio of at least 8% such as a GMR head since the noise can be reduced even when the magnetic layer is densely filled with the iron nitride magnetic powder. In addition, in the iron nitride magnetic powder of the present invention, magnetic characteristics such as a coercive force are deteriorated slightly by increasing the thickness of the outer layer, but such a deterioration in the magnetic characteristics can be compensated and the reduction in the output can be suppressed by the magnetic recording and reproduction system comprising the above high-sensitivity head. Therefore, a high SNR can be achieved, if the magnetic recording medium of the present invention is applied to the magnetic recording and reproduction system having such a reproduction head.

### Examples

Hereinafter, the present invention will be described in more detail by the examples which, however, should not be construed as limiting the scope of the present invention in any way. In the following examples, “parts” are “parts by weight,” unless otherwise specified.

Production of Iron Nitride-Based Magnetic Powders

Ten (10) parts of magnetite powder shown in Table 1 as a starting material was dispersed in 500 parts of water for 30 minutes with an ultrasonic disperser. To the resulting dispersion, a solution containing yttrium nitrate and sodium aluminate therein was added at the addition rate shown in Table 1 to vary the addition amount while maintaining the temperature of the dispersion at 30° C. Then, an aqueous solution of sodium hydroxide was added to adjust pH at 7 to 8 to coat the surfaces of the powder particles with the hydroxides of yttrium and aluminum. Thereafter, the dispersion was washed with water and filtered, and the material recovered by filtration was dried at 110° C. in an air to obtain a magnetite powder having coating elements.

The magnetite powder comprising the coating elements thus obtained was reduced by heating it at 450° C. for 2 hours in a hydrogen gas stream and the cooled to form an iron metal powder. Next, the obtained iron metal powder was cooled to 150° C. over about 1 hour while flowing a hydrogen gas. When the iron metal powder were cooled to 150° C., the hydrogen gas was switched to an ammonia gas, and the iron metal powder was nitrided for 30 hours while maintaining the temperature at 150° C. Thereafter, the iron metal powder was cooled from 150° C. to 100° C. while flowing the ammonia gas. When the temperature reached 100° C., the ammonia gas was switched to a gas mixture of oxygen and nitrogen to stabilize the iron metal powder for 2 hours. Then, the iron metal powder were cooled from 100° C. to 30° C. while flowing the gas mixture, and then an iron nitride magnetic powder was taken out into the air.

With each iron nitride magnetic powder thus produced, the following properties were measured. The results of the measurements are shown in Table 1.

Shape, Average Particle Size, and Average Diameter of Core

Fifty particles of the iron nitride magnetic powder were observed with a high-resolution analytical transmission electron microscope to determine the shapes and average particle size of the powder and the average diameter of the cores. The measurements were performed at a magnification of 100,000 at an electron beam accelerating voltage of 200 kV. When the powder and the core had anisotropic shapes such as an ellipsoid, the largest sizes of the powder particle and the largest diameter of the core were taken as a particle size of the powder particle and a diameter of the core.

Crystal Phase

The X-ray diffraction pattern of the iron nitride magnetic powder was measured to identify a primary phase of the crystalline phase.

Average Contents of Yttrium and Aluminum and Standard Deviations Thereof

At 10 points of the outer layer of each of 50 particles of the iron nitride magnetic powder, elemental compositions were analyzed by an X-ray analysis-transmission electron microscope (TEM-EDX) to determine the average contents of yttrium and aluminum based on the total number of iron atoms in the iron nitride magnetic powder and the standard deviations of the contents of yttrium and aluminum. A detection energy was set at 1.0 to 30 keV.

Magnetic Characteristics

The coercive force and saturation magnetization of the iron nitride magnetic powder were measured with a vibrating sample magnetometer (VSM). The measurement was performed under the conditions of the maximum applied magnetic field of 1270 kA/m and a magnetic field sweep rate of 80 kA/m/min.

TABLE 1

| | | Iron nitride magnetic powder | | | | | | | | | |
|---|---|---|---|---|---|---|---|---|---|---|---|
| | | N-1 | N-2 | N-3 | N-4 | N-5 | N-6 | N-7 | N-8 | N-9 | N-10 |
| Starting | Shape | spherical | spherical | spherical | spherical | spherical | spherical | spherical | spherical | spherical | spherical |
| Material | Average | 19.3 | 20.8 | 11.7 | 19.3 | 19.3 | 21.0 | 19.4 | 19.2 | 11.7 | 6.9 |
| | particle size | | | | | | | | | | |
| | (nm) | | | | | | | | | | |
| | Al/Fe (at %) | 2 | 0 | 3 | 2 | 0 | 0 | 3 | 3 | 3 | 3 |
| Addition rate (g/hr/1 g) | | 0.08 | 0.08 | 0.04 | 0.06 | 0.06 | 1.20 | 1.20 | 0.06 | 0.06 | 0.04 |
| Shape | | spherical | spherical | spherical | spherical | spherical | spherical | spherical | spherical | spherical | spherical to |
| | | to | to | to | to | to | to | to | to | to | ellipsoidal |
| | | ellipsoidal | ellipsoidal | ellipsoidal | ellipsoidal | ellipsoidal | ellipsoidal | ellipsoidal | ellipsoidal | ellipsoidal | |
| Average particle size r | | 18.3 | 19.8 | 10.7 | 18.3 | 18.1 | 20.0 | 18.5 | 18.2 | 12.8 | 5.0 |
| (nm) | | | | | | | | | | | |
| Average diameter d of | | 8.0 | 9.4 | 4.0 | 8.1 | 8.0 | 12.0 | 8.0 | 5.7 | 4.0 | 2.3 |
| core (nm) | | | | | | | | | | | |
| r/d | | 2.3 | 2.1 | 2.7 | 2.3 | 2.2 | 1.7 | 2.3 | 3.2 | 3.2 | 2.1 |
| Crystal phase | | Fe₁₆N₂ | Fe₁₆N₂ | Fe₁₆N₂ | Fe₁₆N₂ | Fe₁₆N₂ | Fe₁₆N₂ | Fe₁₆N₂ | Fe₁₆N₂ | Fe₁₆N₂ | Fe₁₆N₂ |
| Y/Fe | Average content | 0.92 | 0.92 | 4.8 | 0.92 | 0.91 | 0.2 | 1.14 | 4.5 | 5.1 | 0.92 |
| | (at %) | | | | | | | | | | |
| | Standard | 0.59 | 0.57 | 0.59 | 0.39 | 0.40 | 0.59 | 0.85 | 0.58 | 0.87 | 0.58 |
| | deviation | | | | | | | | | | |
| | (at %) | | | | | | | | | | |
| Al/Fe | Average content | 44.9 | 31.5 | 48.1 | 44.8 | 44.5 | 27.1 | 45.1 | 47.3 | 51.2 | 41.3 |
| | (at %) | | | | | | | | | | |
| | Standard | 16.9 | 15.1 | 16.8 | 14.2 | 15.1 | 17.2 | 23.1 | 16.9 | 22.2 | 16.6 |
| | deviation | | | | | | | | | | |
| | (at %) | | | | | | | | | | |

| | | | | | | | | | | |
|---|---|---|---|---|---|---|---|---|---|---|
| Coercive force (kA/m) | 151 | 160 | 127 | 158 | 157 | 167 | 151 | 134 | 125 | 0 |
| Saturation | 41 | 51 | 39 | 45 | 46 | 60 | 42 | 35 | 38 | 53 |
| magnetization (Am²/kg) | | | | | | | | | | |

As shown in Table 1, it is seen that iron nitride magnetic powder, in which the standard deviations of the contents of yttrium and aluminum were small and the surfaces of the powder particles were uniformly coated with these elements could be obtained even when a thick outer layer was formed on the core by changing the addition rate of the coating element to the starting material. Further, it is seen that the standard deviation of the content of Al could be further decreased by the use of the starting material containing aluminum. It is found that although the iron nitride magnetic powder of the Examples according to the present invention had a thick outer layer, the reduction in magnetic characteristics was small since the ratio of the average particle size to the average diameter of the core fell within a range of 2 to 3.

In contrast, when the average particle size was 20 nm or less and the average diameter of the core exceeded 10 nm, the contents of the elements could not be increased and the thickness of the outer layer was small (N-6). Further, it was found that when the contents of the coating elements were high, if the addition rate of the coating elements was high, the standard deviations of the contents of the elements increased and all the elements were unevenly coated (N-7). Furthermore, it was found that the deterioration in magnetic characteristics increased when the thickness of the outer layer was excessively increased relative to the average diameter of the core (N-8). It is found that the outer layer excessively high in coating element contents had an excessively large thickness and the standard deviations of the contents increased (N-9). In addition, it was found that when an average diameter of the core was too small, a superparamagnetic property appeared even if the core contained the Fe₁₆N₂ phase, and the iron nitride magnetic powder could not be used as a magnetic powder (N-10).

Next, a magnetic tape was produced using the iron nitride magnetic powder produced as described above.

Production of Magnetic Tape

Preparation of Magnetic Coating Composition

Using the iron nitride magnetic powder produced as described above, Components (1) of a magnetic coating composition having the composition shown in Table 2 were kneaded with a kneader, and then the kneaded mixture was dispersed with a sand mill (residence time: 60 minutes), and to the resulting dispersion, Components (2) of the magnetic coating composition having the composition shown in Table 3 were added, and the resulting mixture was stirred and filtered to prepare a magnetic coating composition.

TABLE 2

| Components (1) of magnetic coating composition | Amount |
|---|---|
| Iron nitride-based magnetic powder produced as described | 100 parts |
| above | |
| Vinyl chloride-hydroxypropyl methacrylate copolymer resin | 12 parts |
| (containing —SO₃Na groups: 0.7 × 10⁻⁴ equivalent weight/g) | |
| Polyester polyurethane resin | 7 parts |
| (containing —SO₃Na groups: 1.0 × 10⁻⁴ equivalent weight/g) | |
| α-Alumina (average particle size: 80 nm) | 10 parts |
| Carbon black (average particle size: 25 nm) | 1.5 parts |
| Myristic acid | 1.5 parts |
| Methyl ethyl ketone | 133 parts |
| Toluene | 100 parts |

TABLE 3

| Components (2) of Magnetic coating composition | Amount |
|---|---|
| Stearic acid | 1.5 parts |
| Polyisocyanate | 5 parts |
| (“Coronate L” produced by NIPPON POLYURETHANE | |
| INDUSTRY CO.,LTD.) | |
| Methyl ethyl ketone | 133 parts |
| Toluene | 33 parts |

Preparation of Coating Composition for Primer Layer

The components of a coating composition for a primer layer shown in Table 4 were kneaded with a kneader, and then the kneaded material was dispersed with a sand mill (residence time: 60 minutes), and to the resulting dispersion, 6 parts of polyisocyanate was added, and the resulting mixture was stirred and filtered to prepare a coating composition for the primer layer.

TABLE 4

| Components of coating composition for primer layer | Amount | |
|---|---|---|
| Iron oxide powder (average particle size: 55 nm) | 70 | parts |
| A-Alumina (average particle size: 80 nm) | 10 | parts |
| Carbon black (average particle size: 25 nm) | 20 | parts |
| Vinyl chloride-hydroxypropyl methacrylate copolymer resin | 10 | parts |
| (containing —SO₃Na groups: 0.7 × 10⁻⁴ equivalent | | |
| weight/g) | | |
| Polyester polyurethane resin | 5 | parts |
| (containing —SO₃Na groups: 1.0 × 10⁻⁴ equivalent | | |
| weight/g) | | |
| Methyl ethyl ketone | 130 | parts |
| Toluene | 80 | parts |
| Cyclohexanone | 65 | parts |
| Myristic acid | 1 | part |
| Butyl stearate | 1.5 | parts |

Preparation of Coating Composition for Backcoat Layer

The components of a coating composition for the backcoat layer shown in Table 5 were dispersed with a sand mill (residence time: 45 minutes), and to the resulting dispersion, 8.5 parts of polyisocyanate was added, and the resulting mixture was stirred and filtered to prepare a coating composition for the backcoat layer.

TABLE 5

| Components of coating composition for backcoat layer | Amount | |
|---|---|---|
| Carbon black (average particle size: 25 nm) | 40.5 | parts |
| Carbon black (average particle size: 370 nm) | 0.5 | part |
| Barium sulfate | 4 | parts |
| Nitrocellulose | 28 | parts |
| Polyurethane resin (containing —SO₃Na groups) | 20 | parts |
| Methyl ethyl ketone | 100 | parts |
| Toluene | 100 | parts |
| Cyclohexanone | 100 | parts |

Preparation of Magnetic Tape

Firstly, the coating composition for the primer layer was applied to a polyethylene terephthalate film as a non-magnetic substrate in such a way that the thickness of the coating composition after being dried and calendered was 1 μm to form a primer layer, and then the magnetic coating composition was applied onto the resulting primer layer in such a way that the thickness of the magnetic coating composition after being dried and calendered was 80 nm. The magnetic coating composition was dried while performing an orientation treatment in the longitudinal direction to form a primer layer and a magnetic layer.

Next, the coating composition for a backcoat layer was applied to a surface of the substrate opposite to the surface on which the magnetic layer had been formed in such a way that the thickness of the coating composition after being dried and calendered was 700 nm, and dried to form a backcoat layer.

A magnetic sheet consisting of the non-magnetic substrate with the non-magnetic layer and the magnetic layer formed on one surface of the non-magnetic substrate, and with the backcoat layer formed on the other surface thereof as described above was specular finished with a five-staged calender (temperature: 70° C.; linear pressure: 150 Kg/cm), and was wound around a sheet core. The wound magnetic sheet was aged for 48 hours at 60° C. and 40% RH. Thereafter, the magnetic sheet was cut into strips each ½ inch wide to prepare a magnetic tape.

The following electromagnetic conversion characteristics of each of the magnetic tapes thus prepared were evaluated. The results of the evaluation are shown in Table 6.

Electromagnetic Conversion Characteristics

A drum tester equipped with a MIG (metal-in-gap) head (track width: 12 μm, gap length: 0.15 μm, BS: 1.2 T) as a recording head and a spin valve type GMR head (track width: 2.5 μm, SH-SH width: 0.15 μm) as a reproduction head was used to evaluate electromagnetic conversion characteristics of the magnetic tape. A magnetic tape was wound around the rotary drum of the drum tester, and a reproduction output (S), a broadband noise (N) and an SNR at a recording density of 169 kfci were measured with a spectrum analyzer while running the magnetic tape at a relative speed of 3.4 m/s. The reproduction output, noise and SNR were evaluated as relative values to those (0 dB) of Comparative Example 1.

TABLE 6

| | Iron nitride | | | |
|---|---|---|---|---|
| | magnetic powder | S (dB) | N (dB) | SNR (dB) |
| Example 1 | N-1 | −1.9 | −3.5 | +1.6 |
| Example 2 | N-2 | −1.0 | −2.7 | +1.7 |
| Example 3 | N-3 | −2.3 | −4.3 | +2.0 |
| Example 4 | N-4 | −1.5 | −3.7 | +2.2 |
| Example 5 | N-5 | −1.7 | −3.4 | +1.7 |
| Comparative | N-6 | 0 | 0 | 0 |
| Example 1 | | | | |
| Comparative | N-7 | −1.9 | −1.8 | −0.1 |
| Example 2 | | | | |
| Comparative | N-8 | −5.3 | −4.1 | −1.2 |
| Example 3 | | | | |
| Comparative | N-9 | −2.3 | −1.8 | −0.5 |
| Example 4 | | | | |

As can be seen from the results in Table 6, in the magnetic tapes of Examples 1-5, although the output was deteriorated slightly, the noise was significantly reduced and high SNR was attained in comparison with the magnetic tapes of Comparative Example 1 which used conventional iron nitride magnetic powder having a thin outer layer. The reason for this may be that the iron nitride magnetic powder used in the Examples had a relatively thick outer layer, and the magnetic interaction between the particles of the iron nitride magnetic powder adjacent to each other was reduced since the magnetic powder particles were uniformly coated with yttrium and aluminum in the outer layer.

In contrast, the magnetic tape of Comparative Example 2 using the iron nitride magnetic powder which had a rather thick outer layer but was unevenly coated with yttrium and aluminum did not have the effect of reducing noise and the SNR of the magnetic tape was deteriorated. This may be attributed to the fact that parts having a small thickness were formed in the outer layer because the iron nitride magnetic powder particles were unevenly coated with yttrium and aluminum. Further, it was found that the magnetic tape of Comparative Example 3 using the iron nitride magnetic powder with an excessively thick outer layer had the same effect of reducing noise as those in the Examples but had the SNR which was not adequately improved because of a large reduction in the output. This may be attributed to the fact that the magnetic characteristics were deteriorated because the thickness of the outer layer was excessively increased relative to the diameter of the core. Furthermore, it was found that in the magnetic tape of Comparative Example 4 using the iron nitride magnetic powder excessively high in yttrium and aluminum contents, not only the output was reduced but also the level of noise was increased.

What is claimed is:

1. A spherical or ellipsoidal iron nitride magnetic powder having a core comprising iron nitride including a Fe₁₆N₂ phase as a primary phase and an outer layer containing yttrium and aluminum,
wherein an average particle size r of the iron nitride magnetic powder is 20 nm or less, an average diameter d of the core is 4 to 10 nm, and a ratio of r to d (r/d) is 2 to 3, and
wherein an average content of yttrium in the outer layer is from 0.9 to 5 atomic % based on the total number of iron atoms in the iron nitride magnetic powder and a standard deviation of the content of yttrium is 0.6 atomic % or less, and an average content of aluminum is from 30 to 50 atomic % based on the total number of iron atoms in the iron nitride magnetic powder and a standard deviation of the content of aluminum is 17 atomic % or less, when elemental analyses are carried out at 10 points of the outer layer of each of 50 particles of the iron nitride magnetic powder by an X-ray analysis-transmission electron microscope.

2. A magnetic recording medium comprising a non-magnetic substrate and a magnetic layer containing an iron nitride magnetic powder according to claim 1 and a binder on said non-magnetic substrate.

3. The magnetic recording medium according to claim 2, which is utilized for a magnetic recording and reproduction system comprising a magnetoresistance effect device having a magnetoresistance ratio of at least 8% as a reproduction head.
